(19) United States
(12) Patent Application Publication
(10) Pub. No.: US 2008/0003396 A1
(43) Pub. Date: Jan. 3, 2008

(54) Water-soluble coatings for media

(76) Inventors: Molly L. Hladik, Corvallis, OR (US); Susan E. Bailey, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/453,672

(22) Filed: Jun. 15, 2006

(51) Int. Cl. B32B 3/02

(52) U.S. Cl. 428/64.4

(57) ABSTRACT

Water-soluble polymer layers, image recording media, and methods for preparing an image recording medium, are disclosed.

### BACKGROUND

Compositions that produce a color change upon exposure to energy in the form of light are of great interest in producing images on a variety of substrates. For example, labeling of optical storage media such as Compact Discs, Digital Video Discs, or Blue Laser Discs (CD, DVD, or Blue Laser Disc) can be routinely accomplished through screen-printing methods. While this method can provide a wide variety of label content, it tends to be cost ineffective for run lengths less than 300-400 discs because the fixed cost of unique materials and set-up are shared by all the discs in each run. In screen-printing, a stencil of the image is prepared, placed in contact with the disc, and then ink is spread by squeegee across the stencil surface. Where there are openings in the stencil the ink passes through to the surface of the disc, thus producing the image. Preparation of the stencil can be an elaborate, time-consuming, and expensive process.

In recent years, significant increases in use of CD/DVD discs as a data distribution vehicle have increased the need to provide customized label content to reflect the data content of the disc. For these applications, the screen-label printing presents a dilemma as discs are designed to permit customized user information to be recorded in standardized CD, DVD, or Blue Laser Disc formats. Today, for labeling small quantities of discs, popular methods include hand labeling with a permanent marker pen, using an inkjet printer to print an adhesive paper label, and printing directly with a pen on the disc media, which has a coating that has the ability to absorb inks. The hand printing methods do not provide high quality, and aligning a separately printed label by hand is inexact and difficult.

It may therefore be desirable to design an optical data recording medium (e.g., CD, DVD, or Blue Laser Disc) which can be individually labeled by the user easily and inexpensively relative to screen-printing, while giving a high quality label solution. It may also be desirable to design an optical data recording medium that accepts labeling via multiple methods, thus reducing the amount of inventory necessarily carried by optical data recording merchants and end users.

### SUMMARY

Briefly described, embodiments of this disclosure include water-soluble polymer layers, image recording media, and methods for preparing an image recording medium. One exemplary embodiment of a water-soluble polymer layer, among others, includes: a water-soluble polymer; a radiation absorbing compound disposed in the water-soluble polymer; an activator disposed in the water-soluble polymer; and a color former disposed in the water-soluble polymer.

One exemplary embodiment of image recording medium, among others, includes: a substrate having a layer disposed thereon. The layer includes a water-soluble polymer, a radiation absorbing compound disposed in the water-soluble polymer, an activator disposed in the water-soluble-polymer, and a color former disposed in the water-soluble-polymer.

One exemplary embodiment of methods for preparing an image recording medium, among others, includes: providing a water-soluble polymer, a radiation absorbing compound, an activator, and a color former; mixing the water-soluble polymer, the radiation absorbing compound, the activator, and the color former; and disposing the direct imaging material onto a substrate.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding parts throughout the several views.

FIG. 1 illustrates an embodiment of a media processing system.

FIG. 2 illustrates a flow diagram of a representative embodiment for processing print media.

### DETAILED DESCRIPTION

Embodiments of the present disclosure will employ, unless otherwise indicated, techniques of synthetic organic chemistry, ink chemistry, media chemistry, and the like, that are within the skill of the art. Such techniques are explained fully in the literature.

The following examples are put forth so as to provide those of ordinary skill in the art with a complete disclosure and description of how to perform the methods and use the compositions disclosed and claimed herein. Efforts have been made to ensure accuracy with respect to numbers (e.g., amounts, temperature, etc.) but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the term “leuco-dye” means a color-forming substance that is colorless or of a first color in a non-activated state, and subsequently exhibits color or changes from the first color to a second color in an activated state.

As used herein, the term “activator” is a substance, that reacts with a leuco-dye, causing the leuco-dye to alter its chemical structure and change or acquire color. By way of example only, activators may be phenolic or other proton-donating species that can effect this change.

As used herein, the term “antenna” is a radiation-absorbing compound. The antenna readily absorbs a desired specific wavelength of the marking radiation.

### DISCUSSION

Water-soluble polymer compositions (e.g., direct imaging materials), water-soluble polymer composition layers (e.g., direct imaging layer), substrates including water-soluble polymer composition layers, and methods of making each, are provided. In general, embodiments of the present disclosure can be used in different environments than radiation curable materials (e.g., UV curable polymers) and layers. In addition, embodiments of the present disclosure do not require the equipment needed when using radiation curable materials. Further, embodiments of the present disclosure do not generate the waste produced when using radiation curable materials. Furthermore, embodiments of the present disclosure can be used with packaging (e.g., food packaging) that other materials can not be used with. Also, the emissions are environmentally benign because water-soluble polymers are used as opposed to volatile organic solvents.

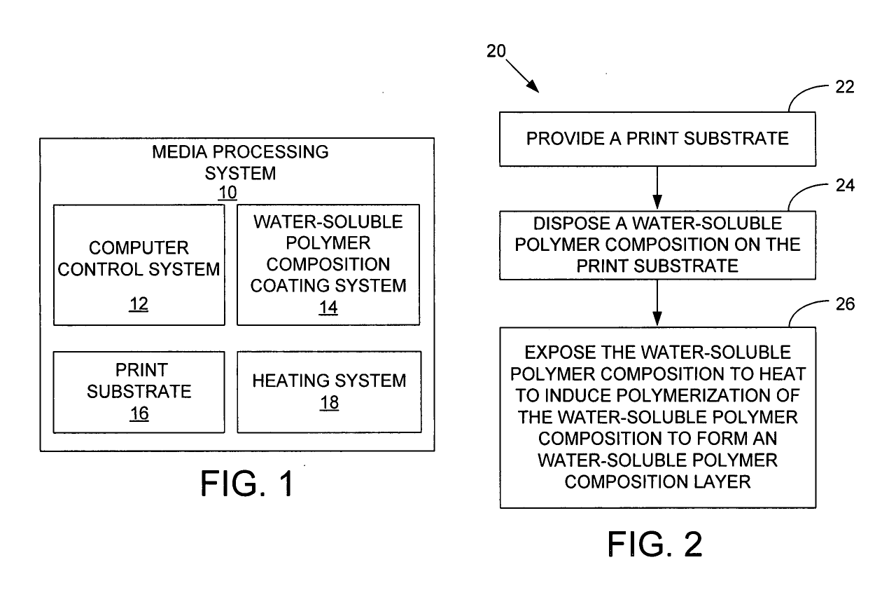

FIG. 1 illustrates a representative embodiment of a media processing system 10. The media processing system 10 can include, but is not limited to, a computer control system 12, a water-soluble polymer composition coating system 14, a print substrate 16, and a heating system 18. The computer control system 12 is operative to control the dispensing of a water-soluble polymer composition on the print substrate 16 using the water-soluble polymer composition coating system 14. In addition, the computer control system 12 is operative to initiate the polymerization of the water-soluble polymer composition by controlling the heating system 18. In this regard, the heating system 18 irradiates the water-soluble polymer composition dispensed on the print substrate 16.

The heating system 18 can include, but is not limited to, a heater, an appropriate heat circulation system, and other systems or components that can promote the polymerization of the water-soluble polymer composition.

The water-soluble polymer composition coating system 14 is configured to store and dispense the water-soluble polymer composition onto the print substrate 16. The water-soluble polymer composition coating system 14 can include one or more compartments that store the components of the water-soluble polymer composition until the components are dispensed. In general, the components of the water-soluble polymer composition are premixed and dispensed onto the print substrate 16 as a mixture. The water-soluble polymer composition coating system 14 can include, but is not limited to, curtain coating systems, slot coating systems, rod coating systems, gravure coating systems, blade coating systems, combinations thereof, as well as other coating systems used in the preparation of print media.

FIG. 2 is a flow diagram describing a representative method 20 for fabricating print media using the media processing system 10. In block 22, a print substrate 16 is provided. The print substrate 16 can be a substrate upon which it is desirable to make a mark, such as, but not limited to, paper and/or plastic substrates (e.g., labels, tickets, receipts, food packaging, or stationery), overhead transparencies, a metal/metal composite, glass, a ceramic, a polymer, a woven cloth, a non-woven cloth material, and a labeling medium (e.g., a compact disk (CD) (e.g., CD-R/RW/ROM) and a digital video disk (DVD) (e.g., DVD-R/RW/ROM)).

In particular, the print substrate 16 includes an “optical disk” which is meant to encompass audio, video, multi-media, and/or software disks that are machine readable in a CD and/or DVD drive, or the like. Examples of optical disk formats include writeable, recordable, and rewriteable disks such as DVD, DVD-R, DVD-RW, DVD+R, DVD+RW, DVD-RAM, CD, CD-ROM, CD-R, CD-RW, and the like. Other like formats can also be included, such as similar formats and formats to be developed in the future. The print substrate 16 may be from about 2 mils to about 12 mils thick, depending on a desired end application for the print medium.

In block 24, the water-soluble polymer composition is disposed onto the print substrate 16 using the water-soluble polymer composition coating system 14. In block 26, the water-soluble polymer composition is exposed to heat using the heating system 18, which promotes the polymerization of the water-soluble polymer composition and forms a water-soluble polymer layer. Additional processing can be performed after the water-soluble polymer layer is formed. In an embodiment, when the water-soluble polymer layer is thermally cross-linked, the water-soluble polymer layer may be substantially water-soluble (e.g., not completely water-soluble) and may be swellable.

The water-soluble polymer composition can include, but is not limited to, at least one water-soluble polymer, a color former, and an activator. In addition, the water-soluble polymer composition can include, but is not limited to, a radiation absorbing compound, a crosslinking agent, hollow beads, and the like. The water-soluble polymer composition may also include other components not described here.

To form a mark, radiation energy is directed imagewise at one or more discrete areas of the water-soluble polymer layer 14 of the print substrate 16. The form of radiation energy may vary depending upon the equipment available, ambient conditions, the desired result, and the like. The radiation energy can include, but is not limited to, infrared (IR) radiation, ultraviolet (UV) radiation, x-rays, and visible light. The radiation absorbing compound functions to absorb energy, convert the energy into heat, and deliver the heat to the reactants. The energy may then be applied by the way of an infrared laser. Upon application of the energy, both the activator and the color former may become heated (e.g., solubilizing the color former) and mix, which causes the color former to become activated and cause a mark (color) to be produced.

In the following description of the water-soluble polymer composition, oligomers can include compounds having from about 2 to 50 monomer units of one or more types of monomers. Also, the following description lists various monomer units, and it should be understood the oligomers of these monomers, individually or in combination, can also be included in the water-soluble polymer composition.

The water-soluble polymer can include, but is not limited to, monomers, oligomers, polymers, and combinations thereof. The water-soluble polymer can include, but is not limited to, a single type of polymer, a mixture of a single type of polymer of differing molecular weights, a mixture of different polymers of various molecular weights, a mixture of polymers (single type or different polymer types) with different glass transition temperatures (Tg), and the like.

The water-soluble polymer can include, but is not limited to, polyvinyl alcohol, cationic polyvinylalcohol, acetoacetylated polyvinylalcohol, silylated polyvinylalcohol, carboxylated polyvinylalcohol, polyvinylpyrrolidone, copolymer of polyvinylacetate and polyvinylpyrrolidone, copolymer of polyvinylalcohol and polyvinylpyrrolidone, cationic polyvinylpyrrolidone, gelain, hydroxyethylcellulose, methyl cellulose, polyethyleneimine, polyallylamine, polyvinylamine, dicyandiamide-polyalkylenepolyamine condensate, polyalkylenepolyamine-dicyandiamideammonium condensate, dicyandiamide-formalin condensate, an addition polymer of epichlorohydrin-dialkylamine, a polymer of diallyldimethylammoniumchloride (“DADMAC”), a copolymer of diallyldimethylammoniumchloride-SO₂, polyvinylimidazole, polyvinylpyrrolidone, a copolymer of vinylimidazole, polyamidine, chitosan, cationized starch, polymers of vinylbenzyltrimethylqammoniumchloride, (2-methacryloyloxyethyl)trimethyl-ammoniumchloride, and polymers of dimethylaminoethylmethacrylate, a polyvinylalcohol with a pendant quaternary ammonium salt, and combinations thereof.

In addition, the water-soluble polymer can include, but is not limited to, water dispersible polymers, gelatin, emulsion polymers (e.g., styrene butadiene particle, styrene acrylic particle, vinyl acrylic particle, all acrylic particle, polyurethane dispersions, and polyester dispersions). The water-soluble polymer can be about 10 wt % to 60 wt % of the layer, about 5 wt % to 30 wt % of the layer, and about 5 wt % to 10 wt % of the layer.

The term “color former” is a color forming substance, which is colorless or one color in a non-activated state and produces or changes color in an activated state. The color former can include, but is not limited to, leuco dyes and phthalide color formers (e.g., fluoran leuco dyes and phthalide color formers as described in “The Chemistry and Applications of Leuco Dyes”, Muthyala, Ramiah, ed., Plenum Press (1997) (ISBN 0-306-45459-9), which is incorporated herein by reference).

The color forming composition can include, but is not limited to, a wide variety of leuco dyes. Suitable leuco dyes include, but are not limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)-4,5-diphenylimidazoles, indanones, leuco indamines, hydrozines, leuco indigoid dyes, amino-2,3-dihydroanthraquinones, tetrahalo-p,p′-biphenols, 2(p-hydroxyphenyl)-4,5-diphenylimidazoles, phenethylanilines, phthalocyanine precursors (such as those available from Sitaram Chemicals, India), and other known leuco dye compositions. Experimental testing has shown that fluoran based dyes are one class of leuco dyes which exhibit particularly desirable properties.

In one aspect of the present disclosure, the leuco dye can be a fluoran, phthalide, aminotriarylmethane, or mixture thereof. Several non-limiting examples of suitable fluoran based leuco dyes include 3-diethylamino-6-methyl-7-anilinofluorane, 3-(N-ethyl-p-toluidino)-6-meth-yl-7-anilinofluorane, 3-(N-ethyl-N-isoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(N-cyclohexyl-N-methylamino)-6-methyl-7-anilinofluorane, 3-diethylamino-7-(m-trifluoromethylanilino)fluorane, 3-dibutylamino-6-methyl-7-anilinofluorane, 3-diethylamino-6-chloro-7-anilinofluorane, 3-dibutylamino-7-(o-chloroanilino)fluorane, 3-diethylamino-7-(o-chloroanilino)fluorane, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofuranone, 4,5,6,7-tetrachloro-3,3-bis[2-[4-(dimethylamino)phenyl]-2-(4-methoxyphenyl)ethenyl]-, 2-anilino-3-methyl-6-(N-ethyl-N-isoamylamino)fluorane (S-205 available from Nagase Co., Ltd), and mixtures thereof.

Suitable aminotriarylmethane leuco dyes can also be used in the present invention, such as tris(N,N-dimethylaminophenyl)methane (LCV), tris(N,N-diethylaminophenyl) methane (LECV), tris(N,N-di-n-propylaminophenyl)methane (LPCV), tris(N,N-di-n-butylaminophenyl) methane (LBCV), bis(4-diethylaminophenyl)- -(4-diethylamino-2-methyl-phenyl)methane (LV-1), bis(4-diethylamino-2-methylphenyl)-(4-diethylamino-phenyl)methane (LV-2), tris(4-diethylamino-2-methylphenyl)methane (LV-3), bis(4-diethylamino-2-methylphenyl)(3,4-dimethoxy-phenyl)methane (LB-8), aminotriarylmethane leuco dyes having different alkyl substituents bonded to the amino moieties wherein each alkyl group is independently selected from C1-C4 alkyl, and aminotriaryl methane leuco dyes with any of the preceding named structures that are further substituted with one or more alkyl groups on the aryl rings wherein the latter alkyl groups are independently selected from C1-C3 alkyl. Other leuco dyes can also be used in connection with the present invention and are known to those skilled in the art. A more detailed discussion of some of these types of leuco dyes may be found in U.S. Pat. Nos. 3,658,543 and 6,251,571, each of which are hereby incorporated by reference in their entireties. Additional examples and methods of forming such compounds can be found in Chemistry and Applications of Leuco Dyes, Muthyala, Ramaiha, ed., Plenum Press, New York, London, ISBN: 0-306-45459-9, which is hereby incorporated by reference.

The color former can be about 3 wt % to 35 wt % of the layer, about 10 wt % to 30 wt % of the layer, and about 10 wt % to 20 wt % of the layer.

The term “radiation absorbing compound” (e.g., an antenna) means any radiation absorbing compound in which the antenna readily absorbs a desired specific wavelength of the marking radiation. The radiation absorbing compound may be a material that effectively absorbs the type of energy to be applied to the print substrate 16 to effect a mark or color change. The radiation absorbing compound can include, but is not limited to, IR780 (Aldrich 42,531-1) (1) (3H-Indolium, 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propyl-, iodide (9CI)); IR783 (Aldrich 54,329-2) (2) (2-[2-[2-Chloro-3-[2-[1,3-dihydro-3,3-dimethyl-1-(4-sulfobutyl)-2H-indol-2-ylidene]-ethylidene]-1-cyclohexen-1-yl]-ethenyl]-3,3-dimethyl-1-(4-sulfobutyl)-3H-indolium hydroxide, inner salt sodium salt); Syntec 9/1 (3)); Syntec 9/3 (4); or metal complexes (e.g., dithiolane metal complexes (5) and indoaniline metal complexes (6)).

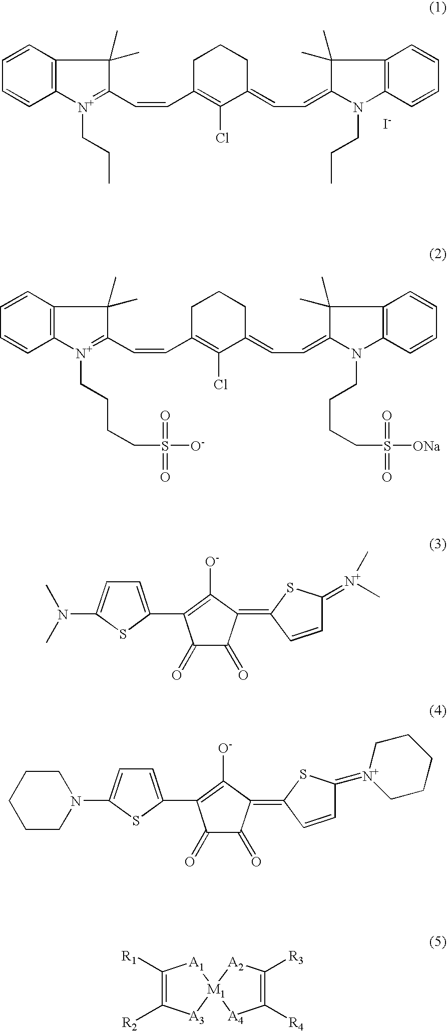

where M₁ is a transition metal, R₁, R₂, R₃, and R₄ are alkyl or aryl groups with or without halo substituents, and A₁, A₂, A₃, and A₄ can be S, NH, or Se;

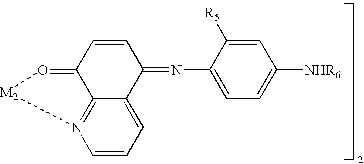

where M₂ is Ni or Cu and R5 and R₆ are aryl or alkyl groups with or without halo substituents.

Additional examples of radiation absorbing compounds can be found in “Infrared Absorbing Dyes”, Matsuoka, Masaru, ed., Plenum Press (1990) (ISBN 0-306-434784) and “Near-Infrared Dyes for High Technology Applications”, Daehne, S.; Resch-Genger, U.; Wolfbeis, O., Ed., Kluwer Academic Publishers (ISBN 0-7923-5101-0), both incorporated herein by reference.

The radiation absorbing compound can be about 0.2 wt % to 5 wt % of the layer, about 0.2 wt % to 2 wt % of the layer, and about 0.2 wt % to 0.6 wt % of the layer.

As used herein, the term “activator” is a substance that reacts with a color former, causing the color former to alter its chemical structure and change or acquire color.

The activator can include a compound that has an acid such as, but not limited to, a Lewis acid, has a functionality such as a complexed transition metal, metal salt, phenolic compound, and combinations thereof, and can be reactive with leuco dyes with or without introduction of energy in the form of light and/or heat.

In one embodiment, the activator can be a metal salt of an aromatic carboxylic acid. The metal of the metal salt can include, but is not limited to, transition metals such as zinc, tin, nickel, iron, and other transition metals. In one embodiment, the metal salt activator can be a zinc salt of an aromatic carboxylic acid. Other metal salt activators include zinc salicylate, tin salicylate, zinc 2-hydroxy naphthoate, 3,5-di-α-methylbenzyl zinc salicylate, metal salts of rhodanate, xanthate, aluminate, titanate, and zirconate, and mixtures thereof.

The activator can include, but is not limited to, a phenolic resin, zinc chloride bisphenol, hydroxybenzoate, amidophenol, anilides with hydroxyl groups, and benzoamides with hydroxyl groups including N-(4-Hydroxyphenyl) acetamide, 2-acetamidophenol, 3-acetamidophenol, salicylanilide, p-hydroxybenzamide, p-hydroxyphenyl acetamide, 3-hydroxy-2-napthanilide, o-hydroxybenzanilide, 4-hydroxyphenyl sulfone, 2,4′-dihydroxyd iphenyl sulfone, Bis(4-hydroxy-3-allylphenyl) sulfone, 2,2′,5,5′-Tetrahydroxy diphenyl sulfone, 4-hydroxyphenyl-4′-isopropoxyphenly sulfone, 2,2-Bis(4-hydroxyphenyl)propane, and combinations thereof.

The activator can be about 2 wt % to 20 wt % of the layer, about 2 wt % to 15 wt % of the layer, and about 2 wt % to 10 wt % of the layer.

The crosslinking agent can include, but is not limited to, boron compounds. For example, the boron compounds can include, but are not limited to, borax, boric acid, borate (e.g., orthoborate, InBO₃, ScBO₃, YBO₃, LaBO₃, Mg₃(BO₃)₂, and CO₃(BO₃)₂), diborate (e.g., Mg₂B₂O₅ and CO₂B₂O₅), metaborate (e.g., LiBO₂, Ca(BO₂)₂, NaBO₂, and KBO₂), tetraborate (e.g., Na₂B₄O₇ 10H₂O), and pentaborate (e.g., KB₅O₈ 4H₂O, Ca₂B₆O₁₁ 7H₂O, and CsB₅O₅). In an embodiment, the crosslinking agent can be at least one of borax, boric acid, and borate.

In addition, the crosslinking agent can include, but is not limited to, aldehyde compounds (e.g., formaldehyde, glyoxal and glutaraldehyde); ketone compounds (e.g., diacetyl and cyclopentanedione); active halogen compounds (e.g., bis(2-chloroethylurea)-2-hydroxy-4,6-dichloro-1,3,5-triazine and 2,4-dichloro-6-s-triazine sodium salt); active vinyl compounds (e.g., divinyl sulfonic acid, 1,3-vinylsulfonyl-2-propanol, N,N′-ethylene-bis(vinylsulfonylacetamide), and 1,3,5-triacryloyl-hexahyd r-o-s-triazine); N-methylol compounds (e.g., dimethylolurea and methyloldimethylhydantoin); melamine resins (e.g., methylolmelamine and alkylated methylolmelamine); epoxy resins; isocyanate compounds (e.g., 1,6-hexamethylenediisocyanate); aziridine compounds disclosed in U.S. Pat. Nos. 3,017,280 and 2,983,611; carboxyimide compounds disclosed in U.S. Pat. No. 3,100,704 which are incorporated herein by reference; epoxy compounds (e.g., glycerol triglycidyl ether); ethyleneimino compounds (e.g., 1,6-hexamethylene-N,N′-bis-ethyleneurea); halogenated carboxyaldehyde compounds (e.g., mucochloric acid and mucophenoxychloric acid); dioxane compounds (e.g., 2,3-dihydroxydioxane); metal-containing compounds (e.g., titanium lactate, aluminum sulfate, chromium alum, potassium alum, zirconyl acetate and chromiumacetate); polyamine compounds (e.g., tetraethylenepentamine); hydrazide compounds (e.g., adipic dihydrazide); and low molecular weight compounds and polymers having 2 or more oxazoline groups.

The crosslinking agent can be about 0.5 wt % to 2 wt % of the layer, about 0.2 wt % to 1 wt % of the layer, and about 0.2 wt % to 0.75 wt % of the layer.

The term “hollow bead” refers to hollow plastic pigments, and the like, that include one or more void(s) within the outer dimension of the pigment volume. The hollow beads can have a void volume from 20% to 70% and about 30% to 60%. In addition, the hollow beads can have a diameter from about 0.3 to 10 μm, about 0.3 to 5 μm, and about 0.3 to 2 μm. Further, the hollow beads can have a glass transition temperature (Tg) above about 50° C., above about 70° C., above about 90° C., from about 50° C. to 120° C., from about 50° C. to 120° C., from about 70° C. to 120° C., and from about 90° C. to 120° C. Furthermore, in embodiments of the present disclosure, the hollow beads used for a particular application have substantially the same diameter.

The hollow beads can be derived from chemicals such as, but not limited to, acid monomers, non-ionic monoethylenically unsaturated monomers, and polyethylenically unsaturated monomers. The acid monomers can include, but are not limited to, acrylic acid, methacrylic acid, and mixtures thereof; and acryloxypropionic acid, methacryloxypropionic acid, acryloxyacetic acid, methacryloxyacetic acid, and monomethyl acid itaconate. The nonionic monoethylenically unsaturated monomers can include, but are not limited to, styrene and styrene derivatives (e.g. alkyl, chloro- and bromo-containing styrene), vinyltoluene, ethylene, vinyl esters (e.g. vinyl acetate, vinylformate, vinylacetate, vinylpropionate, vinylbenzoate, vinylpivalate, vinyl 2-ethylhexanoate, vinyl methacrylate, vinyl neodecanoate, and vinyl neononanoate), vinyl versatate, vinyl laurate, vinyl stearate, vinyl myristate, vinyl butyrate, vinyl valerate, vinyl chloride, vinylidene chloride, acrylonitrile, methacrylonitrile, acrylamide, (meth)acrylamide, t-butylacrylamide, t-butyl methacrylamide, isopropylarylamide, isopropylmethacrylamide, and C₁-C₂₀ alkyl or C₃ -C₂₀ alkenyl esters of (meth)acrylic acid.

The expression “(meth)acrylic acid” is intended to serve as a generic expression embracing both acrylic acid and methacrylic acid (e.g., methyl methacrylate, t-butylmethacrylate, methyl acrylate, ethyl (meth)acrylate, butyl (meth)acrylate, 2-ethylhexyl (meth)acrylate, benzyl (meth)acrylate, lauryl (meth)acrylate, oleyl (meth)acrylate, palmityl (meth)acrylate, stearyl (meth)acrylate, hydroxyl containing (meth)acrylate (e.g., hydroxyethylacrylate, hydroxyethylmethacrylate, hydroxypropylacrylate, hydroxypropylmethacrylate, and 2,3-Dihydroxypropyl methacrylate)). Polyethylenically unsaturated monomers can include, but are not limited to, ethylene glycol di(meth)acrylate, allyl (meth)acrylate, 1,3-butane-diol di(meth)acrylate, diethylene glycol di(meth)acrylate, trimethylol propane trimethacrylate, and divinyl benzene.

In particular, the hollow beads can include, but are not limited to, an acrylic or styrene acrylic emulsion, such as Ropaque® HP-543, Ropaque® HP-643, Ropaque® HP-1055, or Ropaque® OP-96 (available from Rohm and Haas Co. (Philadelphia, Pa.)), or Dow HS 2000NA, Dow 3000NA, Dow 3020NA, or Dow 3042NA (available from Dow Chemical Co. (Midland, Mich.)).

The hollow beads can be about 1 wt % to 20 wt % of the layer, about 1 wt % to 10 wt % of the layer, and about 1 wt % to 5 wt % of the layer

Various buffering agents or pH adjusting agents can also be optionally used in the ink compositions of the present disclosure. Typical buffering agents include such pH control solutions as hydroxides of alkali metals and amines, such as lithium hydroxide, sodium hydroxide, potassium hydroxide; citric acid; amines such as triethanolamine, diethanolamine, and dimethylethanolamine; hydrochloric acid; and other basic or acidic components which do not substantially interfere with the bleed control or optical density characteristics of the present invention. If used, buffering agents typically comprise less than about 10 wt % of the ink composition.

Various biocides can be used to inhibit growth of undesirable microorganisms. Several non-limiting examples of suitable biocides include benzoate salts, sorbate salts, commercial products such as NUOSEPT (Nudex, Inc., a division of Huls America), UCARCIDE (Union Carbide), VANCIDE (RT Vanderbilt Co.), and PROXEL (ICI Americas), and other known biocides.

Surfactants can also be present, such as alkyl polyethylene oxides, alkyl phenyl polyethylene oxides, polyethylene oxide (PEO) block copolymers, acetylenic PEO, PEO esters, PEO amines, PEO amides, and dimethicone copolyols. If used, such surfactants can be about 0.5 wt % to 5 wt % of the layer, about 0.5 wt % to 2.5 wt % of the layer, and about 0.5 wt % to 1 wt % of the layer.

As mentioned above, when the water-soluble polymer composition is applied to the substrate, it forms the water-soluble polymer layer. The water-soluble polymer layer has a thickness of about 1 grams per square meter (GSM) to 15 GSM.

The water-soluble polymer layer may be applied to the print substrate 16 via any acceptable method, such as, but not limited to, rolling, spraying, and screen-printing. In addition, one or more layers can be formed between the water-soluble polymer layer and the substrate 16, and/or one or more layers can be formed on top of the water-soluble polymer layer. In one embodiment, the water-soluble polymer layer is part of substrate 16 (e.g., a CD or a DVD).

While embodiments of the present disclosure are described in connection with Examples 1 through 2 and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLE 1

In an illustrative embodiment, the water-soluble polymer composition can have the following composition.

| Chemical | Wt % dry solid in formulation |
|---|---|
| PVOH | 10 ± 5% |
| Zinc Acetate | 15 ± 5% |
| Antenna | 4 ± 5% |
| Ropaque 1055 | 40 ± 5% |
| Color former | 25 ± 5% |
| Boric Acid | 0.5 ± 0.3% |

Water is added to achive percent solids along with the components that are predispersed in water, which, for this formulation, the percent solid was about 25%.

### EXAMPLE 2

In an illustrative embodiment, the water-soluble polymer composition can have the following composition.

| Chemical | Wt % dry solid in formulation |
|---|---|
| PVOH | 30 ± 5% |
| Color former | 30 ± 5% |
| Zinc Acetate | 30 ± 5% |
| Boric acid | 5 ± 1% of a 3% solution in water |
| Antenna | 1 ± 0.5% |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range.

Many variations and modifications may be made to the above-described embodiments. All such modifications and variations are intended to be included herein within the scope of this disclosure and protected by the following claims.

At least the following is claimed:

1. A water-soluble polymer layer comprising:
a water-soluble polymer;
a radiation absorbing compound disposed in the water-soluble polymer;
an activator disposed in the water-soluble polymer; and
a color former disposed in the water-soluble polymer.

2. The water-soluble polymer layer of claim 1, wherein the water-soluble polymer is selected from at least one of the following: polyvinyl alcohol, cationic polyvinylalcohol, acetoacetylated polyvinylalcohol, silylated polyvinylalcohol, carboxylated polyvinylalcohol, polyvinylpyrrolidone, copolymer of polyvinylacetate and polyvinylpyrrolidone, copolymer of polyvinylalcohol and polyvinylpyrrolidone, cationic polyvinylpyrrolidone, gelain, hydroxyethylcellulose, methyl cellulose, polyethyleneimine, polyallylamine, polyvinylamine, dicyandiamide-polyalkylenepolyamine condensate, polyalkylenepolyamine-dicyandiamideammonium condensate, dicyandiamide-formalin condensate, an addition polymer of epichlorohydrin-dialkylamine, a polymer of diallyldimethylammoniumchloride (“DADMAC”), a copolymer of diallyldimethylammoniumchloride-SO₂, polyvinylimidazole, polyvinylpyrrolidone, a copolymer of vinylimidazole, polyamidine, chitosan, cationized starch, polymers of vinylbenzyltrimethylqammoniumchloride, (2-methacryloyloxyethyl)trimethyl-ammoniumchloride, polymers of dimethylaminoethylmethacrylate, a polyvinylalcohol with a pendant quaternary ammonium salt, and combinations thereof.

3. The water-soluble polymer layer of claim 1, wherein the water-soluble polymer is selected from at least one of the following: water dispersible polymers, gelatin, emulsion polymers, and combinations thereof.

4. The water-soluble polymer layer of claim 1, wherein the water-soluble polymer includes polyvinyl alcohol.

5. The water-soluble polymer layer of claim 1, wherein the water-soluble polymer is about 10 to 60 weight percent of the layer, the radiation absorbing compound is about 0.2 to 5 weight percent of the layer, the activator is about 2 to 20 weight percent of the layer, and the color former is about 3 to 35 weight percent of the layer.

6. The water-soluble polymer layer of claim 1, wherein the color former comprises at least one compound selected from a leuco dye and a phthalide dye.

7. The water-soluble polymer layer of claim 1, further comprising a crosslinking agent.

8. The water-soluble polymer layer of claim 1, further comprising hollow beads.

9. The water-soluble polymer layer of claim 1, further comprising a crosslinking agent and hollow beads.

10. The water-soluble polymer layer of claim 9, wherein the crosslinking agent is selected from at least one of the following: borax, boric acid, borate, diborate, metaborate, tetraborate, pentaborate, and combinations thereof.

11. An image recording medium comprising:
a substrate having a layer disposed thereon, wherein the layer includes:
a water-soluble polymer selected from at least one of the following:
polyvinyl alcohol, cationic polyvinylalcohol, acetoacetylated polyvinylalcohol, silylated polyvinylalcohol, carboxylated polyvinylalcohol, polyvinylpyrrolidone, copolymer of polyvinylacetate and polyvinylpyrrolidone, copolymer of polyvinylalcohol and polyvinylpyrrolidone, cationic polyvinylpyrrolidone, gelain, hydroxyethylcellulose, methyl cellulose, polyethyleneimine, polyallylamine, polyvinylamine, dicyandiamide-polyalkylenepolyamine condensate, polyalkylenepolyamine-dicyandiamideammonium condensate, dicyandiamide-formalin condensate, an addition polymer of epichlorohydrin-dialkylamine, a polymer of diallyldimethylammoniumchloride, a copolymer of diallyidimethylammoniumchloride-SO₂, polyvinylimidazole, polyvinylpyrrolidone, a copolymer of vinylimidazole, polyamidine, chitosan, cationized starch, polymers of vinylbenzyltrimethylqammoniumchloride, (2-methacryloyloxyethyl)trimethyl-ammoniumchloride, polymers of dimethylaminoethylmethacrylate, a polyvinylalcohol with a pendant quaternary ammonium salt, and combinations thereof;
a plurality of hollow beads;
a radiation absorbing compound disposed in the water-soluble polymer;
an activator disposed in the water-soluble-polymer; and
a color former disposed in the water-soluble-polymer.

12. The image recording medium of claim 11, wherein the substrate is selected from a paper medium, a transparency, a compact disk (CD), and a digital video disk (DVD).

13. The image recording medium of claim 11, wherein the substrate is selected from a CD-R/RW/ROM and DVD-R/RW/ROM.

14. The image recording medium of claim 11, wherein the layer includes a crosslinking agent.

15. A method for preparing an image recording medium, the method comprising:
providing a water-soluble polymer, a radiation absorbing compound, an activator, and a color former;
mixing the water-soluble polymer, the radiation absorbing compound, the activator, and the color former to form a direct imaging material; and
disposing the direct imaging material onto a substrate.

16. The method of claim 15, wherein the substrate is selected from a paper media, a transparency, a compact disk (CD), and a digital video disk (DVD).

17. The method of claim 15, wherein the water-soluble polymer is selected from at least one of the following: polyvinyl alcohol, cationic polyvinylalcohol, acetoacetylated polyvinylalcohol, silylated polyvinylalcohol, carboxylated polyvinylalcohol, polyvinylpyrrolidone, copolymer of polyvinylacetate and polyvinylpyrrolidone, copolymer of polyvinylalcohol and polyvinylpyrrolidone, cationic polyvinylpyrrolidone, gelain, hydroxyethylcellulose, methyl cellulose, polyethyleneimine, polyallylamine, polyvinylamine, dicyandiamide-polyalkylenepolyamine condensate, polyalkylenepolyamine-dicyandiamideammonium condensate, dicyandiamide-formalin condensate, an addition polymer of epichlorohydrin-dialkylamine, a polymer of diallyldimethylammoniumchloride (“DADMAC”), a copolymer of diallyldimethylammoniumchloride-SO₂, polyvinylimidazole, polyvinylpyrrolidone, a copolymer of vinylimidazole, polyamidine, chitosan, cationized starch, polymers of vinylbenzyltrimethylqammoniumchloride, (2-methacryloyloxyethyl)trimethyl-ammoniumchloride, polymers of dimethylaminoethylmethacrylate, a polyvinylalcohol with a pendant quaternary ammonium salt, and combinations thereof.

18. The method of claim 15, wherein the direct imaging material includes a crosslinking agent and hollow beads.

19. The method of claim 15, wherein the wherein the direct imaging material includes a crosslinking agent.

20. The method of claim 15, wherein the wherein the direct imaging material. includes hollow beads.

21. An image recording medium made by the method of claim 15.
